(19) United States
(12) Patent Application Publication
(10) Pub. No.: US 2012/0306387 A1
(43) Pub. Date: Dec. 6, 2012

(54) LED DRIVER ARRANGEMENT WITH MULTIPLE CURRENT MIRRORS

(75) Inventor: Bruce Robert FERGUSON, Anaheim, CA (US)

(73) Assignee: MICROSEMI CORPORATION, Aliso Viejo, CA (US)

(21) Appl. No.: 13/465,098

(22) Filed: May 7, 2012

Related U.S. Application Data
(60) Provisional application No. 61/491,371, filed on May 31, 2011.

(51) Int. Cl. H05B 37/00

(52) U.S. Cl. 315/185 R

(57) ABSTRACT

A current balancer arrangement constituted of a plurality of current mirror circuits, each of the current mirror circuits comprising a master leg and at least one slave leg is enabled. A constant current source is provided, arranged to provide power for a plurality of LED strings in parallel. Each of the plurality of LED strings is further arranged in series with a master leg of a particular one of the plurality of current mirror circuits, and with the slave leg of each of the balance of the current mirror circuits.

### CROSS-REFERENCE TO RELATED APPLICATIONS

This application claims priority from U.S. Provisional Patent Application Ser. No. 61/491,371 filed May 31, 2011, entitled “LED Driver Arrangement with Multiple Current Mirrors”, the entire contents of which is incorporated herein by reference.

### BACKGROUND OF THE INVENTION

The present invention relates to the field of light emitting diode (LED) based luminaires, and in particular to an arrangement utilizing multiple current mirrors to drive a plurality of LED based luminaires from a single driver.

Light emitting diodes (LEDs) and in particular high intensity and medium intensity LED strings are rapidly coming into wide use for lighting applications. LEDs with an overall high luminance are useful in a number of applications including backlighting for liquid crystal display (LCD) based monitors and televisions, collectively hereinafter referred to as a matrix display, as well as for general lighting applications.

In a large LCD matrix display, and in large solid state lighting applications, such as street lighting, typically the LEDs are supplied in a plurality of strings of serially connected LEDs, at least in part so that in the event of failure of one string at least some light is still output. The constituent LEDs of each LED string thus share a common current.

LEDs providing high luminance exhibit a range of forward voltage drops, denoted V_{f}, and their luminance is primarily a function of current. For example, one manufacturer of LEDs suitable for use with a portable computer, such as a notebook computer, indicates that V_{f} for a particular high luminance white LED ranges from 2.95 volts to 3.65 volts at 20 mA and an LED junction temperature of 25° C., thus exhibiting a variance in V_{f} of greater than ±10%. Furthermore, the luminance of the LEDs vary as a function of junction temperature and age, typically exhibiting a reduced luminance as a function of current with increasing temperature and increasing age.

In order to provide a balanced overall luminance, it is important to control the current of the various LED strings to be approximately equal. In one embodiment a power source is supplied for each LED string, and the voltage of the power source is controlled in a closed loop to ensure that the voltage output of the power source is consonant with the voltage drop of the LED string; however the requirement for a power source for each LED string is quite costly.

Typically, drivers for LED based illumination are designed as constant current sources, thus ensuring that a predetermined current is provided for an attached LED string, irrespective of voltage drop. In order to utilize a plurality of LED strings with a single driver, an active current balancing device is thus required, and the balancing network must be arranged to handle DC currents of the appropriate value.

In one embodiment, known to the prior art, and as shown in FIG. 1, a current mirror circuit 10 is utilized in combination with a constant current driver 20, to drive current through a plurality of LED strings 40. The current mirror circuit exhibits a master leg 30, associated with a particular one of the LED strings 40, and at least one slave leg 50. Each slave leg 50 is associated with a particular LED string 40. Constant current driver 20 is arranged to drive current in parallel to each of the plurality LED strings 40 via current mirror circuit 10.

In operation, current through master leg 30 controls the amount of current through each slave leg 50, such that the current through all of the LED strings 40 are forced to be equal. Unfortunately, such a circuit requires that LED string 40 associated with master leg 30 exhibits a voltage drop equal to, or greater than, the voltage drop of each of the LED strings 40 of the slave legs 50, in order to ensure that sufficient voltage is supplied by the constant current source for the LED strings 40 of each of the slave legs 50. Such a requirement is limiting, and is difficult to ensure in the field.

### SUMMARY OF THE INVENTION

Accordingly, it is a principal object of the present invention to overcome at least some of the disadvantages of the prior art. This is provided in certain embodiments by a current balancer arrangement comprising a plurality of current mirror circuits, each of the current mirror circuits comprising a master leg and at least one slave leg. A constant current source is provided, arranged to provide power for a plurality of LED strings in parallel. Each of the plurality of LED strings is further arranged in series with a master leg of a particular one of the plurality of current mirror circuits, and with the slave leg of each of the balance of the current mirror circuits.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level schematic diagram of an LED driver arrangement for a plurality of LED strings in cooperation with a current mirror circuit according to the prior art;

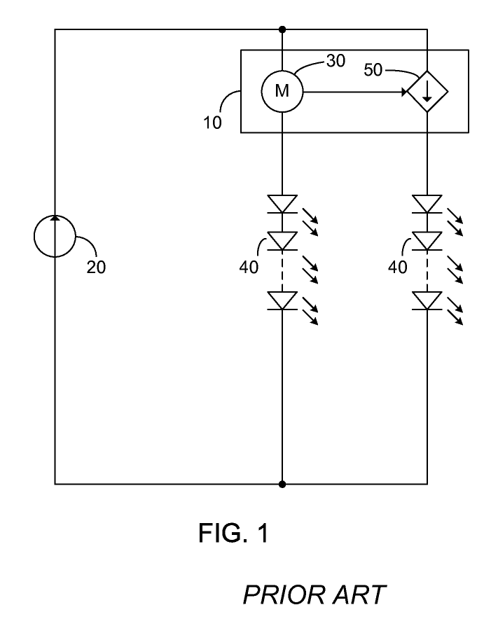

FIG. 2 illustrates a high level schematic diagram of an exemplary embodiment of an LED driver arrangement comprising a plurality of current mirrors;

FIG. 3 illustrates a high level schematic diagram of an exemplary embodiment of an LED driver arrangement comprising a plurality of current mirrors each constituted of bipolar transistors;

FIG. 4 illustrates a high level schematic diagram of an exemplary embodiment of an LED driver arrangement comprising a plurality of current mirrors each constituted of field effect transistors; and

FIG. 5 illustrates a high level schematic diagram of an exemplary embodiment of an LED driver arrangement comprising a plurality of current mirrors and further comprising a protection circuit.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The terms “connected” or “coupled”, or any variant thereof, as used herein is not meant to be limited to a direct connection, and is meant to include any coupling or connection, either direct or indirect, and the use of appropriate resistors, capacitors, inductors and other active and non-active elements does not exceed the scope thereof.

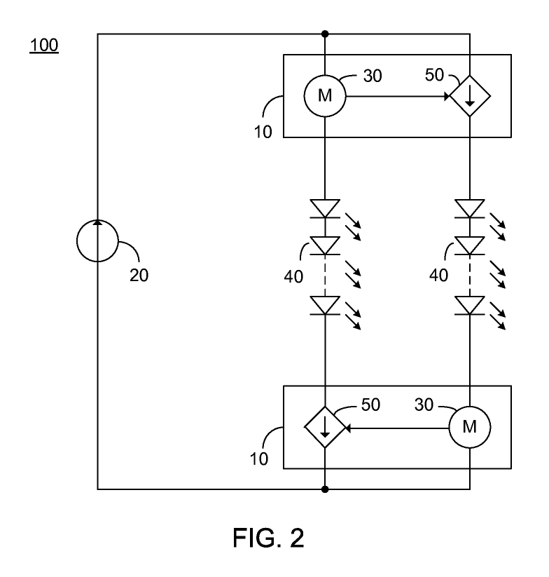

FIG. 2 illustrates a high level schematic diagram of an exemplary embodiment of an LED driver arrangement 100 comprising: a first and a second current mirror 10; a constant current driver 20; and a first and a second LED string 40. Each current mirror 10 comprises a master leg 30 and a slave leg 50.

The output of constant current driver 20 is connected in parallel to a first end of master leg 30 of first current mirror 10 and to a first end of slave leg 50 of first current mirror 10. A second end of master leg 30 of first current mirror 10 is connected to the anode end of first LED string 40, the cathode end of first LED string 40 is connected to a first end of slave leg 50 of second current mirror 10, and a second end of slave leg 50 of second current mirror 10 is connected to the return of constant current driver 20. A second end of slave leg 50 of first current mirror 10 is connected to the anode end of second LED string 40, the cathode end of second LED string 40 is connected to a first end of master leg 30 of second current mirror 10, and a second end of master leg 30 of second current mirror 10 is connected to the return of constant current driver 20.

In operation the output of constant current driver 20 is shared equally between first and second LED string 40 responsive to first and second current mirrors 10. In the event that first LED string 40 exhibits a voltage drop different than the voltage drop of second LED string 40, the voltage difference will reside across the respective current mirror 10. In particular, in the event that the voltage drop across first LED string 40 is greater than the voltage drop across second LED string 40, the voltage difference will appear across slave leg 50 of first current mirror 10; and in the event that the voltage drop across second LED string 40 is greater than the voltage drop across first LED string 40, the voltage difference will appear across slave leg 50 of second current mirror 10.

Advantageously, there is no requirement to ensure that a particular LED string 40 has a predetermined voltage drop relationship to any of the other LED strings 40. Further advantageously, the voltage drop relationship among the various LED strings 40 may change dynamically without affecting the balanced operation of the various LED strings 40.

The above has been described in an embodiment wherein only two current mirrors 10 are illustrated, each associated with a particular one of first and second LED strings 40, however this is not meant to be limiting in any way, and three or more LED strings 40 may be provided without exceeding the scope, each with a respective current mirror 10. Thus, for each LED string 40, a particular current mirror 10 having a master leg 30 in series therewith is supplied, with slave legs 50 of the particular current mirror 10 provided for each of the other LED strings 40.

If either LED string 40 is open circuited, the master leg 30 associated with that LED string 40 will reflect zero current to the slave leg 50 of its current mirror 10, thus disabling the LED string 40 associated with slave leg 50. Constant current driver 20 will sense a very high impedance and is preferably arranged to clamp the output voltage to a predetermined maximum level and shut off the current to its output.

If either LED string 40 has one or more LEDs that is shorted, the current will continue to flow in both LED strings 40 and current will remain matched.

As the voltage across the respective slave leg 50 increases due to the string voltage difference, the constituent element of slave leg 50 will heat up. As long as sufficient heat sinking capacity is provided, LED driver arrangement 100 can operate in this mode indefinitely.

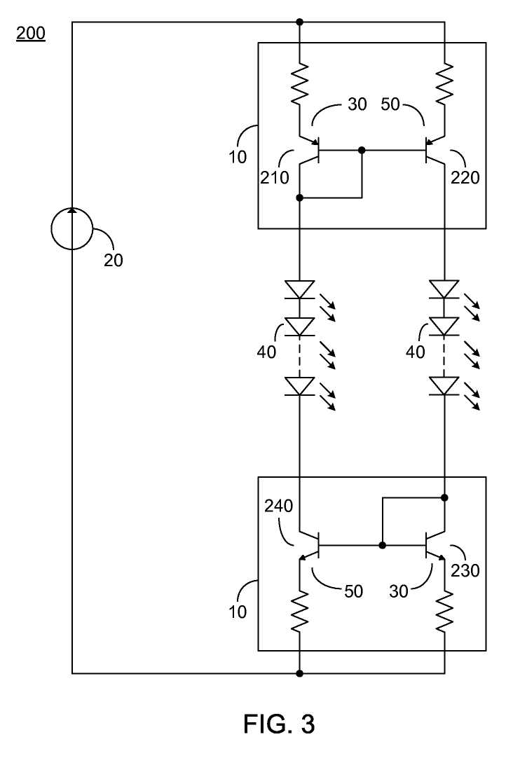

FIG. 3 illustrates a high level schematic diagram of an exemplary embodiment of an LED driver arrangement 200 comprising a plurality of current mirrors 10 each constituted of bipolar transistors. In greater detail, a first current mirror 10 is constituted of a bipolar transistor 210, illustrated as a PNP transistor, acting as master leg 30 and a bipolar transistor 220, illustrated as a PNP transistor, acting as a slave leg 50. A second current mirror 10 is constituted of a bipolar transistor 230, illustrated as an NPN transistor, acting as master leg 30 and a bipolar transistor 240, illustrated as an NPN transistor, acting as a slave leg 50.

Each master leg 30 is arranged with the base terminal of its constituent bipolar transistor 210, 230, respectively, connected to its collector terminal and to the base terminal of the other bipolar transistor in the current mirror. Thus each master leg 30 bipolar transistor 210, 230 is diode connected. Preferably, bipolar transistor 210 and bipolar transistor 220 are matched, so that an equivalent base emitter voltage V_{BE} results in the same collector current I_{C}, assuming equal collector to emitter voltages V_{CE}. Preferably, bipolar transistor 230 and bipolar transistor 240 are matched, so that an equivalent base emitter voltage V_{BE} results in the same collector current I_{C}, assuming equal collector to emitter voltages V_{CE}. Each of bipolar transistor 210, bipolar transistor 220, bipolar transistor 230 and bipolar transistor 240 are arranged with a respective resistor in the emitter leg, with the emitter legs connected via the resistors to the output, and return, respectively, of constant current source 20. Typical resistor values are low, on the order of 1 ohm. There is no requirement that the resistors values be precisely matched, and in particular in certain embodiments the resistor in the emitter leg of bipolar transistor 210 exhibits greater resistance than the resistor in the emitter leg of bipolar transistor 220; and the resistor in the emitter leg of bipolar transistor 230 exhibits greater resistance than the resistor in the emitter leg of bipolar transistor 240. A difference in resistance of 5% is typical.

The slight difference in resistance drives the non-diode connected bipolar transistors 220, 240 harder which pulls them closer to saturation and helps keep the voltage drop across bipolar transistors 220, 240 low, thereby reducing power loss in LED driver arrangement 200.

The operation of LED driver arrangement 200 is in all respects identical with the operation of driver arrangement 100. The respective resistors are provided to balance current mirror 10 in the event that the bipolar transistors of the current mirror 10 are not precisely matched, and thus in an integrated circuit embodiment are not required. The base emitter voltage of bipolar transistor 210 is impressed as the base emitter voltage of bipolar transistor 220, ignoring any voltage drop differences between the emitter leg resistors, thus ensuring a close matching of collector currents. Similarly the base emitter voltage of bipolar transistor 230 is impressed as the base emitter voltage of bipolar transistor 240 thus ensuring a close matching of currents. The emitter to collector voltage of bipolar transistor 220 will tend to equal the emitter to collector voltage of bipolar transistor 210, and the emitter to collector voltage of bipolar transistor 230 will tend to equal the emitter to collector voltage of bipolar transistor 240. Any difference in voltage drop between first and second LED string 40 will appear across the respective slave leg 30 as an additional emitter to collector voltage for the respective bipolar transistor 220, 240. Further advantageously, the tendency to increase current flow through slave leg 30 responsive to the increased emitter to collector voltage of the representative transistor is prevented by the action of the other current mirror 10. The use of bipolar transistors provides the balancing effect with a low headroom voltage of about 2 volts.

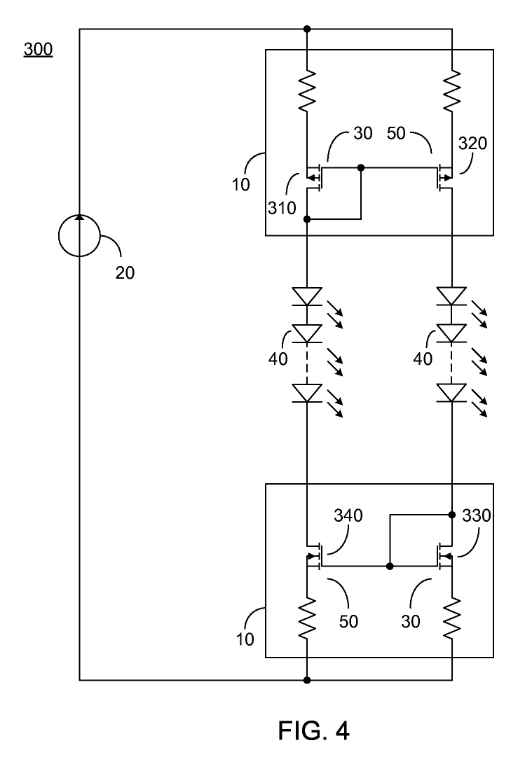

FIG. 4 illustrates a high level schematic diagram of an exemplary embodiment of an LED driver arrangement 300 comprising a plurality of current mirrors 10 each constituted of field effect transistors, illustrated without limitation as MOSFETs. In greater detail, a first current mirror 10 is constituted of a MOSFET 310, illustrated as a PMOSFET, acting as master leg 30 and a MOSFET 320, illustrated as a PMOSFET, acting as a slave leg 50. A second current mirror 10 is constituted of a MOSFET 330, illustrated as an NMOSFET, acting as master leg 30 and a MOSFET 340, illustrated as an NMOSFET, acting as a slave leg 50.

Each master leg 30 MOSFET 310, 330, respectively, is arranged with its gate terminal connected to its drain terminal and to the gate terminal of the other MOSFET 320, 340, respectively, in the current mirror. Preferably, MOSFET 310 and MOSFET 320 are matched, so that an equivalent gate to source voltage V_{GS} results in the same drain current I_{D}, assuming equal drain to gate voltages V_{GD}. Preferably, MOSFET 330 and MOSFET 340 are matched, so that an equivalent gate to source voltage V_{GS} results in the same drain current I_{D}, assuming equal drain to gate voltages V_{GD}. Each of MOSFET 310, MOSFET 320, MOSFET 330 and MOSFET 340 are arranged with a respective resistor in the source leg, with the source legs connected via the resistors to the output, and return, respectively, of constant current source 20. Typical resistor values are low, on the order of 1 ohm.

The operation of LED driver arrangement 300 is in all respects identical with the operation of driver arrangements 100, 200 described above. The respective resistors are provided to balance current mirror 10 in the event that the

MOSFETs of the current mirror 10 are not precisely matched, and thus in an integrated circuit embodiment are not required. V_{GS} of MOSFET 310 is impressed as V_{GS} of MOSFET 320, ignoring any voltage drop differences between the source leg resistors, thus ensuring a close matching of drain currents I_{D}. Similarly V_{GS} of MOSFET 330 is impressed as V_{GS} of MOSFET 340, ignoring any voltage drop differences between the source leg resistors, thus ensuring a close matching of drain currents I_{D}. V_{DG} of MOSFET 320 will tend to equal V_{DG} of MOSFET 310, and V_{DG} of MOSFET 330 will tend to equal V_{DG} of MOSFET 340. Any difference in voltage drop between first and second LED string 40 will appear across the respective slave leg 30 as an additional source to drain voltage for the respective MOSFET 320, 340.

Further advantageously, the tendency to increase current flow through slave leg 30 responsive to the increased source to drain voltage of the representative MOSFET is prevented by the action of the other current mirror 10.

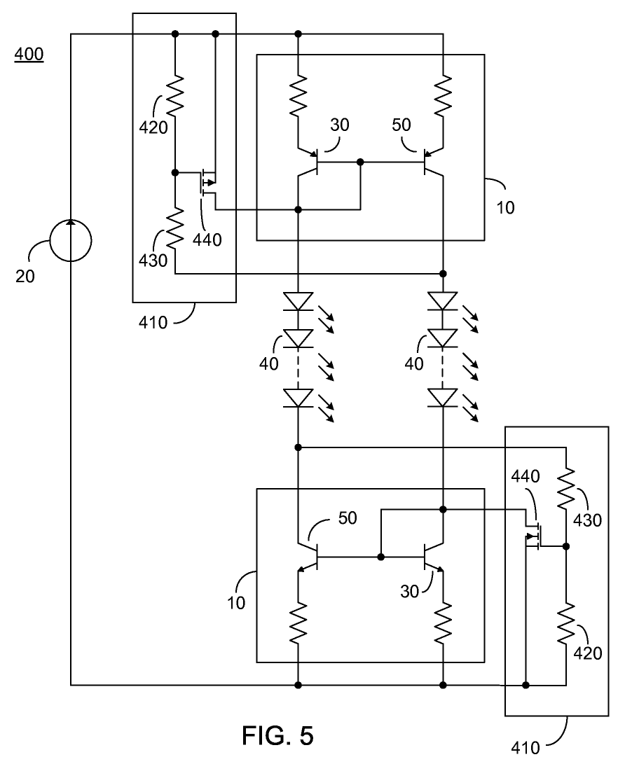

FIG. 5 illustrates a high level schematic diagram of an exemplary embodiment of an LED driver arrangement 400 comprising a plurality of current mirrors, as described above in relation to LED driver arrangement 200, and further comprising a protection circuit 410 associated with each current mirror 10. LED driver arrangement 400 is being particularly described in relation to LED driver arrangement 200, however this is not meant to be limiting in any way, and protection circuitry appropriate for use with LED driving arrangement 100 or LED driving arrangement 300 is specifically contemplated herein.

Protection circuit 410 comprises a resistor divider constituted of resistor 420 and resistor 430 and an electronically controlled switch 440 implemented as a FET. In further detail, a first protection circuit 410, arranged for connection at the high side of LED driving arrangement 400 comprises electronically controlled switch 440 implemented as a PMOSFET 440, with the source connected to the output of constant current driver 20 and the drain connected to common base connection of master leg 30 and slave leg 50. Resistor 420 is connected between the output of constant current driver 20 and the gate of PMOSFET 440, and resistor 430 is connected between the gate of PMOSFET 440 and the collector of slave leg 50. A second protection circuit 410, arranged for connection at the low side of LED driving arrangement 400 comprises electronically controlled switch 440 implemented as an NMOSFET 440, with the source connected to the return of constant current driver 20 and the drain connected to common base connection of master leg 30 and slave leg 50. Resistor 420 is connected between the return of constant current driver 20 and the gate of NMOSFET 440, and resistor 430 is connected between the gate of NMOSFET 440 and the collector of slave leg 50.

In operation, protection circuit 410 acts to scale back the output current in the event that the respective slave 30 collector to emitter voltage exceeds a predetermined threshold. In greater detail, in the event that the voltage drop across slave leg 30 of the respective current mirror 10 increases above a predetermined threshold set by the relationship of resistors 420, 430, electronically controlled switch 440 is triggered to an on state thus passing current to LED string 40 associated with master leg 30 while bypassing master leg 30 of current mirror 10. LED string 40 associated with master leg 30 still experience essentially same voltage, and as such the current there through does not appreciably increase. The current through slave leg 50 is reduced, responsive to the reduced current through master leg 30, thus preventing excess power dissipation in slave leg 50.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described herein above. Rather the scope of the present invention is defined by the appended claims and includes both combinations and sub-combinations of the various features described hereinabove as well as variations and modifications thereof which would occur to persons skilled in the art upon reading the foregoing description and which are not in the prior art.

I claim:

1. A driving arrangement comprising:
a current source;
a plurality of current mirror circuits, each of said plurality of current mirror circuits comprising a master leg and at least one slave leg, the current through the at least one slave leg arranged to be substantially equal to the current through the master leg; and
a plurality of LED based luminaires, each arranged to receive electrical power in parallel from said current source,
each of said plurality of LED based luminaires in series with the master leg of a particular one of said plurality of current mirror circuits and in series with the slave leg of each of the remainder of said plurality of current mirror circuits.

2. The driving arrangement of claim 1, wherein each of said master leg and said at least one slave leg comprises a bipolar junction transistor.

3. The driving arrangement of claim 2, wherein the bipolar junction transistor of said master leg is connected in a diode connected arrangement, and wherein the base terminal of the master leg bipolar junction transistor is connected to the base terminal of the bipolar junction transistor of each of the at least one slave leg.

4. The driving arrangement of claim 1, wherein each of said master leg and said at least one slave leg comprises a field effect transistor.

5. The driving arrangement of claim 4, wherein the gate terminal of the master leg bipolar junction transistor is connected to the gate terminal of the bipolar junction transistor of each of the at least one slave leg.

6. The driving arrangement of claim 1, further comprising a protection circuit in communication with each of the current mirror circuits and arranged to reduce the current passed through the slave leg in the event that the voltage drop across any of the slave legs exceeds a predetermined value.

7. A method of driving a plurality of light emitting diode (LED) strings in parallel, the method comprising:
driving a pre-determined current into one end of two parallel connected LED strings;
mirroring the current through a first of the two parallel connected LED strings to a second of the two parallel connected LED strings, such that the current through the second of the two parallel connected LED strings is substantially equal to the current through the first parallel connected LED string; and
mirroring the current through the second of the two parallel connected LED strings to the first of the two parallel connected LED strings, such that the current through the first of the two parallel connected LED strings is substantially equal to the current through the second parallel connected LED string.

8. The method of claim 7, wherein each of said mirroring the current through the first LED string and said mirroring the current through the second LED string is responsive to a current mirror.

9. The method of claim 7, further comprising:
reducing the mirrored current in the event that the voltage drop across any of the LED strings exceeds a predetermined value.

10. A driving arrangement comprising:
a means for driving a current;
a plurality of current mirroring means, each of said plurality of current mirroring means comprising a master leg and at least one slave leg, the current through the at least one slave leg arranged to be substantially equal to the current through the master leg; and
a plurality of LED based luminaires, each arranged to receive electrical power in parallel from said means for driving,
each of said plurality of LED based luminaires in series with the master leg of a particular one of said plurality of current mirroring means and in series with the slave leg of each of the remainder of said plurality of current mirroring means.

11. The driving arrangement of claim 10, wherein each of said master leg and said at least one slave leg comprises a bipolar junction transistor.

12. The driving arrangement of claim 11, wherein the bipolar junction transistor of said master leg is connected in a diode connected arrangement, and wherein the base terminal of the master leg bipolar junction transistor is connected to the base terminal of the bipolar junction transistor of each of the at least one slave leg.

13. The driving arrangement of claim 10, wherein each of said master leg and said at least one slave leg comprises a field effect transistor.

14. The driving arrangement of claim 13, wherein the gate terminal of the master leg bipolar junction transistor is connected to the gate terminal of the bipolar junction transistor of each of the at least one slave leg.

15. The driving arrangement of claim 10, further comprising a protection circuit in communication with each of the current mirroring means and arranged to reduce the current passed through the slave leg in the event that the voltage drop across any of the slave legs exceeds a predetermined value.
